(19) United States
(12) Patent Application Publication
(10) Pub. No.: US 2010/0086107 A1
(43) Pub. Date: Apr. 8, 2010

(54) Voice-Recognition Based Advertising

(76) Inventor: Yoav M. Tzruya, Even Yehuda (IL)

Correspondence Address: FIALA & WEAVER, P.L.L.C.;C/O CPA GLOBAL, P.O. BOX 52050, MINNEAPOLIS, MN, 55402, US

(21) Appl. No.: 12/566,189

(22) Filed: Sep. 24, 2009

Related U.S. Application Data
(60) Provisional application No. 61/100,489, filed on Sep. 26, 2008.

(51) Int. Cl. H04M 1/64

(52) U.S. Cl. 379/88.01

(57) ABSTRACT

An automated system and a method are provided for delivering and displaying targeted advertisements to users of an end-user device. The end-user device constitutes a dynamic/interactive display and allows users, among other applications, to verbally communicate with other users and/or with automated systems (such as an interactive voice response (IVR) or voice mail system). The end-user device may further be a mobile device (e.g., cellular phone), a static device (e.g., a stand inside a shopping mall) and/or a computing device (such as a personal computer and/or a laptop device). The end-user device allows various voice applications. The system processes the voice communications on the fly, performs speech recognition, and accesses an advertising system to retrieve ads from a server, based on a combination of keywords identified in the recognized speech, as well as additional targeting items, such as user past behavior, user's physical location and more. The ads are then displayed to the user on the end-user device's display.

### CROSS-REFERENCE TO RELATED APPLICATIONS

This application claims priority to U.S. Provisional Patent Application No. 61/100,489, filed Sep. 26, 2008, the entirety of which is incorporated by reference herein.

### BACKGROUND OF THE INVENTION

1. Field of the Invention

The invention generally relates to displaying advertising to a user in a targeted fashion. In particular, the invention relates to a system and a method that performs speech recognition on a user's verbal communications (whether communicating with other users or communicating with a machine, via a human-machine verbal-based interface) and then utilizes text and patterns resulting from such speech recognition as inputs to an advertising server to determine which advertisements to display to an end-user device and which advertisements to display to the user.

2. Background

Advertising is a key revenue stream for many enterprises, both online (Internet), as well as in offline media (newspapers, TV). Voice communications is one of the world's largest industries, comprising both wireline and wireless communications. Voice communications providers have come under tremendous competitive pressures (from Voice over Internet Protocol (VoIP) providers, cable companies, eBay®/Skype™ and others) to lower their end-user fees and cost per minute and see their margins declining, as well as their market share going down. On the other hand, innovative voice communications providers have seen the size of their user base increase, but have struggled to monetize voice traffic, especially when dealing with online voice communications (e.g., Skype™).

In addition, the mobile phone industry has been looking to lower the cost of voice communication and introduce value-added services to consumers. Mobile advertising has been seen as a lucrative potential value-added revenue stream for mobile phone operators. Various implementations, including displaying advertising in response to a search performed on a mobile phone, pre-roll advertising displayed before showing a video online and SMS-based push advertising, are being tried out and enjoy moderate success. In parallel, mobile operators have tried to get advertisers/sponsors to finance the cost of voice calls to consumers (asking the user whether he would like to view/interact with an ad, in return for the advertisers financing some/all of the call's costs).

However, the vast majority of untapped “inventory” for advertising resides with the voice communications themselves. Such voice communications may be processed by PCs, laptops, mobile phones and other end-user devices that allow user-specific communications. For that matter, even a point-of-sale (POS) stand that allows interactive voice response (IVR) communications between a user and an automated response system may be used for the method and system described herein.

Voice communications include a significant amount of information that can help target advertisements to users. This is information that is not utilized today.

When displaying advertisements (ads) to consumers, one may implement various business models including sponsoring the call by the advertisers, giving the user a coupon if he interacts with the ad, monetizing information collected by analyzing the interaction patterns with the ads displayed and more.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

An automated system and method for targeting advertisements to a consumer on an end-user device based on speech recognition processing performed on the user's verbal communications is described herein. The automated system and method for targeting advertisements utilizes speech-recognition that is performed on the device or on a network (e.g., on a voice switch), feeding an ad-serving infrastructure (together with additional data), and relaying the advertisement that has been determined for the user to a client-side application residing on the end-user device. The advertisement may comprise textual information, graphical information and/or audio information (e.g., human speech and/or music).

Also described herein is a computer program product comprising a computer-readable medium having computer program logic recorded thereon for enabling a processor to perform speech-recognition on the user's verbal communication (performed either on the end-user device or in the voice-communication network), integrated with a second computer program responsible for selecting ads based on business logic, taking as inputs user data (e.g., past interaction, geographical location), as well as the result of speech recognition performed on the voice communications. Also described herein is a computer program residing on the end-user device that integrates with the second computer program mentioned above, receiving ads that were determined to be displayed or made available to the user.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a high-level diagram of a system that is operable to perform a method for displaying advertising based on speech recognition of end-user voice communications.

FIG. 2 is a high-level diagram of a set of logical components enabling the performance of a method for displaying advertising based on speech recognition of end-user voice communications, wherein speech recognition is performed on the client-device.

FIG. 3 is a high-level diagram of a set of logical components enabling the performance of a method for displaying advertising based on speech recognition of end-user voice communications, wherein speech recognition is performed in the voice network.

FIG. 4 illustrates a flowchart of a method used to target and display ads to a user based on speech recognition performed on end-user voice communications.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Overview

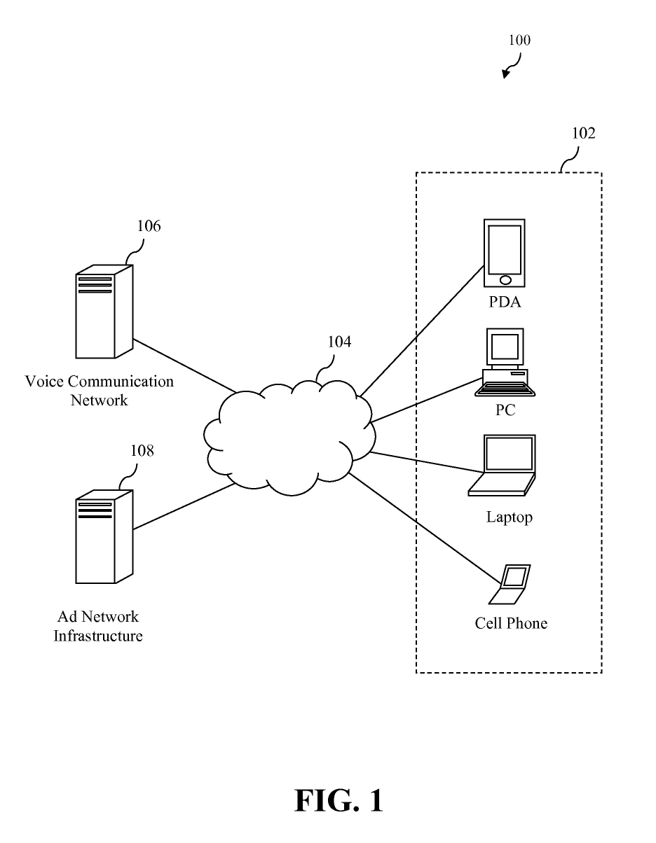

FIG. 1 depicts an example system 100 that is operable to perform a method for displaying targeted ads to an end-user on an end-user device in response to voice communications performed (as part of a bigger system) on such end-user device in accordance with an embodiment of the invention. As shown in FIG. 1, system 100 includes an end-user device 102, a voice communication network 106 and an ad-network infrastructure 108. End-user device 102 typically constitutes a single physical device (such as a cell phone, laptop, PC or PDA). Voice communication network 106 may be comprised of several computing platforms, network elements (e.g., switches, routers, soft-switches), connectivity media (e.g., optical wiring, microwave point-to-point communications and such) and other components. Ad-network infrastructure 108 typically comprises several computing platforms, distributed geographically.

End-user device 102 is a device upon which a user may use any of various voice communications applications available for him on the device. Some examples of such applications include voice-calls performed from a cellular phone, VoIP calls performed through a cable set-top-box, VoIP or peer-to-peer voice communications performed from an end-user laptop or a PC, or any other voice-based communication performed by the user on such devices.

End-user device 102, voice communication network 106 and ad-network infrastructure 108 typically communicate with one another either directly or over a network cloud 104. Network cloud 104 may be part of voice communication network 106 or be a third party network system. Voice communication network 106 and ad-network infrastructure 108 may be operated by a single business entity or may be related to different business entities.

The method performed on end-user device 102, voice communication network 106 and ad-network infrastructure 108 may result in the display of an advertisement to the end-user on end-user device 102.

Voice communication network 106 may comprise the PSTN network, an intelligent network (IN) system, a VoIP infrastructure (including soft switches), a video-communications infrastructure, a peer-to-peer voice communications system, or any other method or system known to persons skilled in the art to enable voice communication by the end-user.

Operating together or separately, voice communication network 106 and end-user device 102 may enable various applications such as user-to-user voice calls, user-to-user video calls, conference calls, interactive voice response (IVR) applications, voice mail access or any other application utilizing verbal communication from the end-user or to the end-user.

It should be apparent to persons skilled in the art that there can be a plurality of voice communication networks 106 on top of which end-user device 102 performs voice communications (depending for example on geographic location or the voice communications application chosen).

It should also be apparent to persons skilled in the art that there can be a plurality of ad-network infrastructures 108 that are part of the system, determining which ads to display and serving advertising media.

### B. System Architecture

As explained above, end-user device 102 is used by the user to perform voice-based communication applications on a possible variety of end-user device types and utilizing various voice-based communications. For example, the voice-based communications can be uni-directional to the user (e.g., voice-mail), uni-directional from the user (e.g., some IVR applications) or bi-directional (e.g., voice calls, video calls, conference calls, etc.). The method described herein is independent of such nature of the voice communication application performed by the end-user or on his behalf by the end-user device.

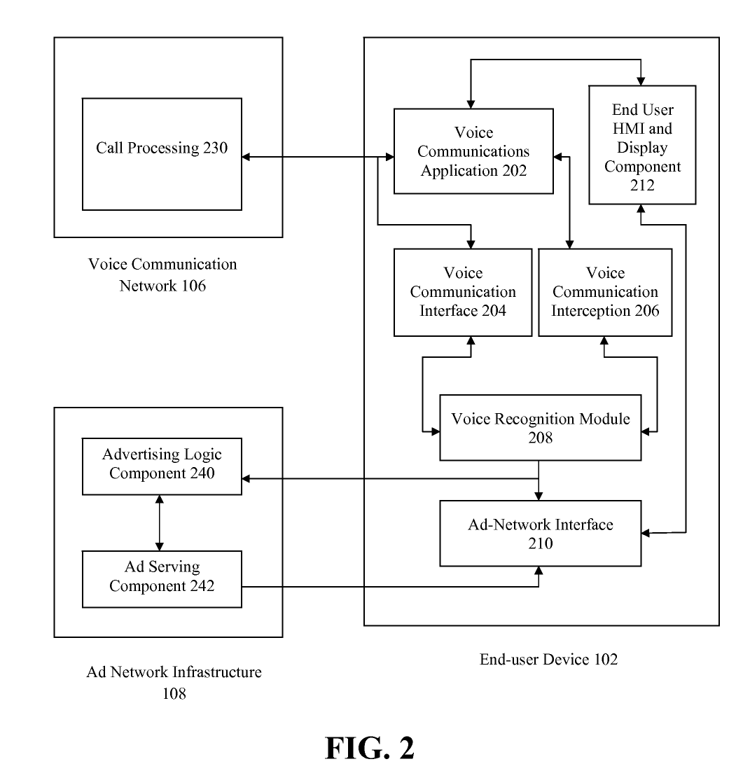

FIG. 2 illustrates an embodiment of a system architecture enabling the method, wherein speech recognition function and logic is performed on the end-user device.

An end-user using end-user device 102 may initiate a certain voice application 202. Voice application 202 may be initiated explicitly as a response to user action or implicitly as a response to an external event, such as an incoming voice call on a cell-phone. Note that a single end-user device 102 may include a plurality of voice applications 202.

During the usage of application 202, voice communication traffic (whether inbound or outbound) is generated.

To perform voice communication on more than just the local environment on the end-user device, voice application 202 may interface with voice communication network 106 and a plurality of call processing components 230.

Voice communication interface component 204 and/or voice communication interception component 206 are able to receive a real-time or near-real-time stream of voice communication as performed in application 202.

Voice communication interface component 204 is part of the system discussed herein. Such component, residing on the end-user device 102, may have been integrated during developing time with application 202 and thus may receive the voice communication stream from application 202.

Voice communication interception component 206 is part of the system discussed herein. Such component, residing on the end-user device 102, may not necessarily been integrated a-priori with application 202 but may be able to receive the stream of voice communication enabled by application 202 by using one or more of various methods known to persons skilled in the art to intercept certain data or voice traffic on the device (e.g., hooking system calls, replacing a device driver, hooking into the operating system, etc.).

Voice communication interface component 204 and/or voice communication interception component 206, having access to the voice communication stream, transfer part or all of the voice stream (based on an application specific logic), to voice recognition module 208.

Voice recognition module 208 may use a combination of methods known to persons skilled in the art to transform voice communications to textual information, thereby capturing the meaning of the voice communications performed by the user or any of the other parties that are part of the voice communication application session. For example, voice recognition module 208 may transform the content of a voice mail message left for the user while the user listens to that message. The voice recognition may be applied to the whole of the message or to part of it. The transcript may be complete or only certain keywords may be logged (e.g., keywords that are part of a dictionary related to the voice recognition module 2008). In an embodiment that uses a dictionary, a typical dictionary size of 10,000 words per language may be enough for the purposes of the system and method described herein.

After acquiring a full or partial transcript of the voice communication, voice recognition module 208 transfers that transcript, or part of it, to ad-network interface component 210. Ad-network interface component 210 may perform additional semantic or grammatical analysis of the transcript and passes a request for advertising to an advertising logic component 240, which is part of ad-network infrastructure 108. The request for advertising may include multiple parameters groups, including ones relating to user specific information, application related information (e.g., what application is used), end-user device information (e.g., where the user currently uses speaker-phone, car-phone or hands-free modes, or the display capabilities characteristics of the end-user device), geographical information (e.g., the coordinates available for cell-phone application through either triangulation or GPS location), past verbal communication history, past interaction pattern with ads or more. The request is typically relayed over a communication network.

Advertising logic component 240, receiving the request for an advertisement from ad-network interface component 210, processes the parameters passed and determines, according to business rules defined in the databases related to the ad-network infrastructure if there is a suitable advertisement, or set of advertisements to be displayed. An advertisement may comprise textual information, visual media (e.g., video, static image), or audio information (e.g., radio-like advertisement). It is possible that advertising logic component 240 may determine that there is no advertisement to be displayed to the user. On the other hand, advertising logic component 240 may determine a plurality of possible ads to be displayed, each with its own characteristics. The result of that determination is communicated back to ad-network interface 210. In addition, advertising logic component 240 may store the request for advertisement, along with any or all of its parameters in a database which is part of the ad network infrastructure 108, for future use, allowing further behavioral targeting methods (known to persons skilled in the art).

Ad-network interface 210, receiving the determination of advertisements to be displayed to the end-user may apply additional logic filtering the set of advertisement descriptors it has received from advertising logic component 240.

Ad-network interface 210 may communicate with ad-serving component 242 to retrieve, if needed, additional media files associated with the ad-set it received in response to its advertising request from advertising logic component 240.

Ad-network interface 210 is further responsible for communicating, on the device, with end-user HMI (human-machine interface) and display component 212. End-user HMI and display component 212 responds to notices from ad-network interface 210 (received in either push or pull modes) and is responsible for communicating to the user the content of relevant determined media ads. This may include displaying an image of the ads, playing an audio file, or providing textual information related to the ad. Furthermore, end-user HMI and display component 212 may enable the user to interact with the advertisement. Such interaction may result in multiple additional steps related to further information provided to the user.

The possible interaction performed by the user with the advertisement, enabled partially by the end-user HMI and display component 212, may be logged into advertising network infrastructure 108 databases using methods known to persons skilled in the art.

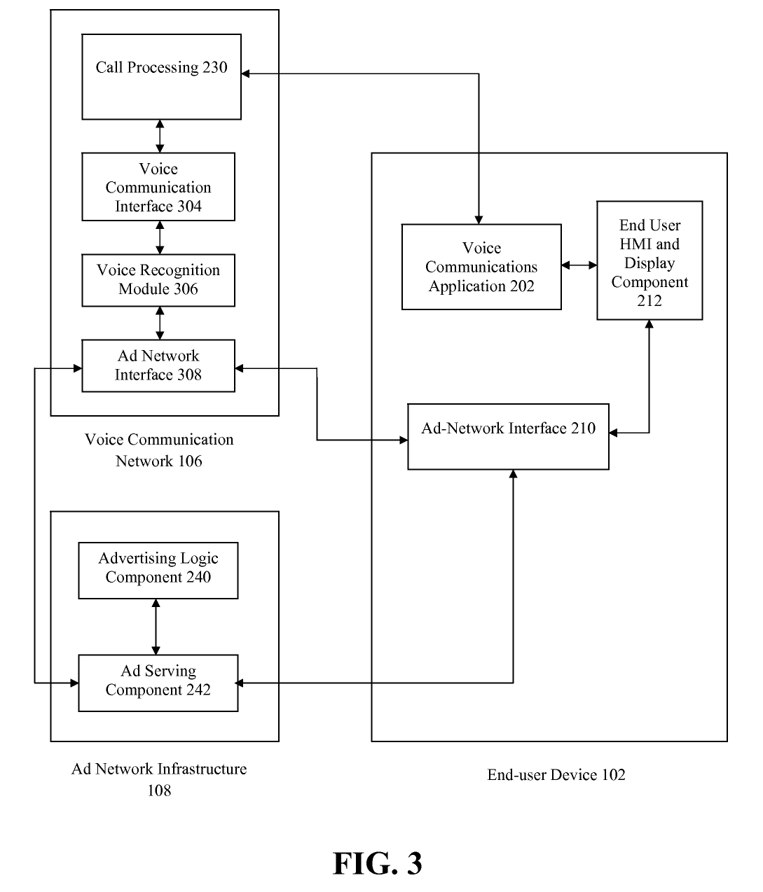

FIG. 3 illustrates an embodiment of a system architecture enabling the method, wherein speech recognition function and logic is performed in the voice communication network 106.

An end-user using end-user device 102 may initiate a certain voice application 202. The voice application may be initiated explicitly as a response to a user action or implicitly as a response to an external event such as an incoming voice call on a cell-phone. Note that a single end-user device 102 may include a plurality of voice applications 202.

During the usage of application 202, voice communication traffic (whether inbound or outbound) is generated.

To perform voice communication on more than just the local environment on the end-user device, voice application 202 may interface with voice communication network 106 and a plurality of call processing components 230. Call processing components 230 may communicate with a plurality of voice communication interfaces 304.

Voice communication interface component 304 is part of the system discussed herein. Such component, residing as part of voice communication network 106, would typically be integrated during developing time with a plurality of call processing components 230 (e.g., with soft switches) and thus may receive voice communication streams from voice applications interfacing with such call processing components 230.

Voice communication interface component 304, having access to a voice communication stream, transfers part or all of the voice stream (based on an application specific logic) to voice recognition module 306.

Voice recognition module 306 may use a combination of methods known to persons skilled in the art to transform voice communications to textual information, thereby capturing the meaning of the voice communications performed by the user or any of the other parties that are part of the voice communication application session. For example, voice recognition module 306 may transform the content of a voice mail message left for the user while the user listens to that message. The voice recognition may be applied to the whole of the message or to part of it. The transcript may be complete or only certain keywords may be logged (e.g., keywords that are part of a dictionary related to the voice recognition module 306). In an embodiment that uses a dictionary, a typical dictionary size of 10,000 words per language may be enough for the purposes of the system and method described herein.

After acquiring a full or partial transcript of the voice communication, voice recognition module 306 transfers that transcript, or part of it, to ad-network interface component 308. Ad-network interface component 308 may perform additional semantic or grammatical analysis of the transcript and passes a request for advertising to the advertising logic component 240, which is part of ad-network infrastructure 108. The request for ad may include multiple parameters groups, including ones relating to user specific information, application related information (e.g., what application is used), end-user device information (e.g., where the user currently uses speaker-phone, car-phone or hands-free modes, or the display capabilities characteristics of the end-user device), geographical information (e.g., the coordinates available for cell-phone application through either triangulation or GPS location), past verbal communication history, past interaction pattern with ads or more. The request is typically relayed over a communication network.

Advertising logic component 240, receiving the request for an advertisement from ad-network interface component 308, processes the parameters passed and determines, according to business rules defined in the databases related to the ad-network infrastructure if there is a suitable advertisement, or set of advertisements to be displayed. An advertisement may comprise textual information, visual media (e.g., video, static image), or audio information (e.g., radio-like advertisement). It is possible that advertising logic component 240 may determine that there is no advertisement to be displayed to the user. On the other hand, advertising logic component 240 may determine a plurality of possible ads to be displayed, each with its own characteristics. The result of that determination is communicated back to ad-network interface 308. In addition, advertising logic component 240 may store the request for advertisement along with any or all of its parameters in a database which is part of the ad network infrastructure 108, for future usage, allowing further behavioral targeting methods (known to persons skilled in the art).

Ad-network interface 308, receiving the determination of advertisements to be displayed to the end-user, may apply additional logic filtering the set of advertisement descriptors it has received from advertising logic component 240.

Ad-network interface 308 may further communicate with ad-network interface 210 on the device (through push or pull interfaces) to deliver the advertisement set to end-user device 102.

Ad-network interface 210 may communicate with ad-serving component 242 to retrieve, if needed, additional media files associated with the ad-set it received in response to its advertising request from advertising logic component 240.

Ad-network interface 210 is further responsible for communicating, on the device, with end-user HMI (human-machine interface) and display component 212. End-user HMI and display component 212 responds to notices from ad-network interface 210 (received in either push or pull modes) and is responsible for communicating to the user the content of relevant determined media ads. This may include displaying an image of the ads, playing an audio file, or providing textual information related to the ad. Furthermore, end-user HMI and display component 212 may enable the user to interact with the advertisement. Such interaction may result in multiple additional steps related to further information provided to the user.

The possible interaction performed by the user with the advertisement, enabled partially by end-user HMI and display component 212, may be logged into advertising network infrastructure 108 databases using methods known to persons skilled in the art.

### C. Example Flow

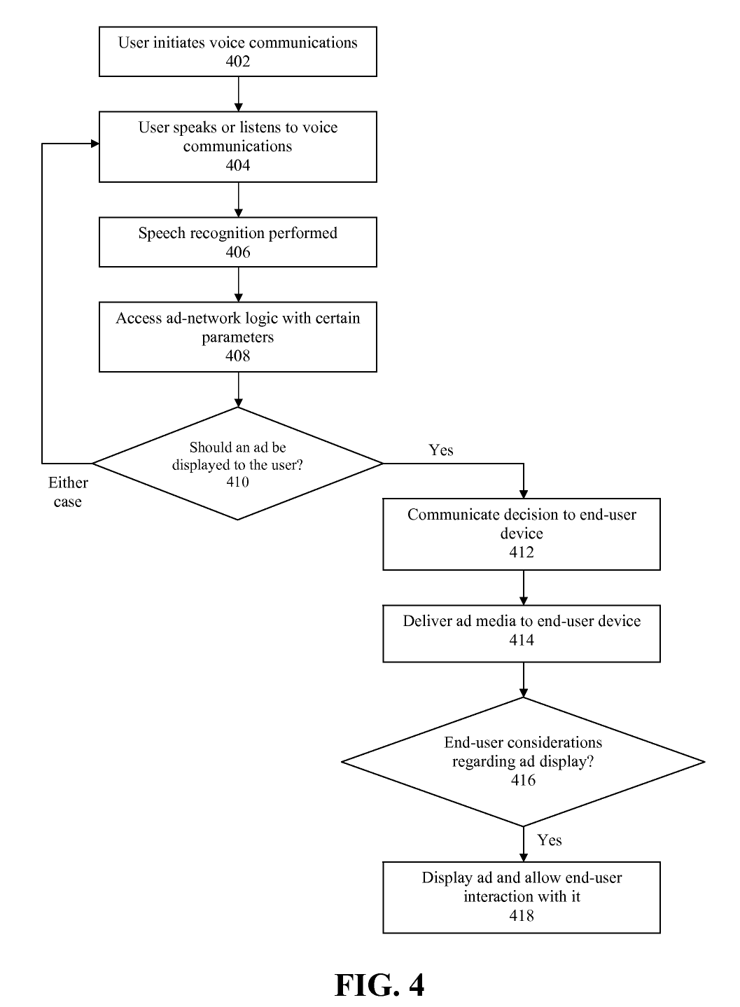

FIG. 4 illustrates an example flow of the method described herein.

In step 402, a user initiates a voice communication session. As an alternative, the voice communication session may be initiated on behalf of the user by the end-user device 102, or the voice communication network 106. For example, if a push-to-talk message has been sent to the user, the application handling it is typically already up and running on the end-user device, and the session is “live” allowing the user to receive such voice communication messages without the need to initiate the application as captured in step 402. Note that a voice communication session may be part of a video call, peer-to-peer communication, conference call, listening to a voice-mail message or voice-activated interface of a certain application the user is utilizing.

As part of the voice communications session, the user may speak or listen to audio traffic (step 404). The audio traffic may include various audio information, including music, as well as voice, verbal, lingual communications.

In step 406, speech recognition is performed on the audio traffic to analyze the verbal, lingual communication pieces that are part of the voice communication session. The result of the speech recognition process is a full or partial transcript of the voice communication session.

In step 408, the ad-network is accessed with multiple sets of parameters, including the full or partial transcript acquired in the manner described above.

In step 410, a decision is made in regards to whether based on the set of parameters pass to the ad-network as part of step 408, an advertisement should be communicated to the end-user on the end-user device. If it is determined that an advertisement should be communicated to the end-user, the method continues to step 412. In any case, whether an advertisement should be communicated to the end-user or not, the method continues to process additional voice communications, as mentioned in steps 404, 406, 408 and 410.

If it was determined that an advertisement should be communicated to the end-user, then in step 412 this decision is communicated to the end-user device, allowing the device to prepare for the communication of such advertisement to the end-user.

In step 414, the advertisement media related to the advertisements determined to be needed to be communicated to the end-user is delivered to the end-user device.

In step 416, additional considerations may be applied to determine if indeed the advertisement should be displayed to the end-user on the end-user device. For example, if the user has moved geographically and the advertisement was a local ad, or if further analysis of end-user voice communications has revealed he is not interested in that kind of ad, or if the user has closed the lid on a clam-shell phone, not allowing a visual ad to be viewed by the user, or if another advertisement is already on display, or if the user is interacting with a past advertisement, then step 416 may conclude that there is no ability and/or no need and/or no benefit to display the ad to the user.

Step 418 performs the actual display and/or sounding of the advertisement to the end-user on the end-user device. Step 418 may further allow the user to interact with that advertisement (e.g., clicking on the advertisement and continuing interaction on an advertisement related landing page). Step 418 may further log the interaction the user has performed with the advertisement, communicate that to the ad-network infrastructure and thus allow various business models to be established based on such logging of the nature of the interaction with the advertisement.

### D. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for dynamically displaying a user with near-real-time advertising, comprising:
(a) a user that utilizes an electronic device, which is used for voice communications;
(b) interception of the said voice communication stream;
(c) analysis and voice recognition of the voice communication stream;
(d) combining the textual information derived from the voice recognition phase with additional user information;
(e) querying an advertisement serving infrastructure with the combined textual information, for one or more personalized advertisements or promotions; and
(f) displaying the user, with one or more of the selected personalized advertisement or promotions.

2. The method of claim 1, wherein the voice communication is performed with either the user device, aimed at the device itself (e.g., voice commands, IVR) or through device, with users utilizing other devices (e.g., phone call, video call).

3. The method of claim 1, wherein the interception of such voice communication stream is performed either on the end-user device or on the voice communication network infrastructure elements (such as a soft-switch, intelligent network (IN) element, switch or other).

4. The method of claim 3, wherein the analysis and voice recognition is performed, in case the interception is performed on the end-user device, either on the end-user device or on a server-side element, to which the voice stream is relayed in real-time.

5. The method of claim 3, wherein the analysis and voice recognition is performed, in case the interception is performed on the network infrastructure, on a server-side element.

6. The method of claim 1, wherein the additional user information may comprise of zero or more of the following:
(a) location information derived from the end-user device;
(b) past behavior by the user as captured by the system, either as part of the same voice communication session, or as part of another voice communication session; and
(c) end-user device information (e.g., screen size, multimedia capabilities).

7. The method of claim 6, wherein past behavior may include zero or more of the following:
(a) past voice communication by the user;
(b) voice communication by other users with whom the user has communicated in the past, or in the current voice communication session;
(c) information about one or more of previous advertisements shown to the user; and
(d) information about one or more previous advertisements with which the user interacted.

8. The method of claim 1, wherein the advertisement selected may be audio advertisement, textual, graphical or video advertisement.

9. The method of claim 1, wherein the advertisement is meant for various forms of interaction by the user (e.g., click-through, barcode scanning, coupon/saving for later use).

10. The method of claim 1, wherein the advertisement should be either pushed to the end-user device by the advertisement serving infrastructure or pulled from the advertisement serving infrastructure by the end-user device.
